(19) United States
(12) Patent Application Publication
(10) Pub. No.: US 2014/0089842 A1
(43) Pub. Date: Mar. 27, 2014

(54) METHOD AND DEVICE FOR INTERFACE DISPLAY

(71) Applicant: TENCENT TECHNOLOGY (SHENZHEN) COMPANY LIMITED, Shenzhen (CN)

(72) Inventors: Ru Lan LIN, Shenzhen (CN); Can Cai YUAN, Shenzhen (CN); Sen Sheng XU, Shenzhen (CN); Hai Feng DING, Shenzhen (CN); Zi Hao CEN, Shenzhen (CN); Jia En LIU, Shenzhen (CN)

(73) Assignee: TENCENT TECHNOLOGY (SHENZHEN) COMPANY LIMITED, Shenzhen (CN)

(21) Appl. No.: 14/091,249

(22) Filed: Nov. 26, 2013

Related U.S. Application Data
(63) Continuation of application No. PCT/CN2013/082348, filed on Aug. 27, 2013.

(30) Foreign Application Priority Data
Aug. 28, 2012 (CN) 201210307637.6

(51) Int. Cl. G06F 3/0484

(52) U.S. Cl. CPC G06F 3/0484
USPC 715/781

(57) ABSTRACT

The present disclosure relates to an interface display method, the method comprising: generating a first screen interface and a second screen interface, wherein the first screen interface displays a functional interface associated with an application, and the second screen interface displays a navigation interface comprising functional modules associated with the application; displaying the first screen interface; displaying the second screen interface when the second screen interface is triggered; and displaying an interface associated with a functional module in the first screen interface when the functional module is selected from the second screen interface. This interface display method accomplishes convenient switching between functional modules without occupying screen display space. The present disclosure also provides an interface display device.

### CROSS REFERENCE TO RELATED APPLICATIONS

This application is a U.S. national application under 35 U.S.C. §111(a) claiming priority, under 35 U.S.C. §120, to International Application No. PCT/CN2013/082348 filed on Aug. 27, 2013, which claims the priority benefit of Chinese Patent Application No. 201210307637.6, filed Aug. 28, 2012, the contents of both the PCT application and the Chinese application are incorporated by reference herein in their entirety for all purposes.

### TECHNICAL FIELD

The present disclosure relates generally to the technological field of the display of application program interfaces, and more particularly, to a method and device for interface display.

### BACKGROUND

With the popularization of smartphones, more and more people choose to complete more tasks on their mobile phones. Applications integrating different functions start to appear. For example, a company developed a mobile phone security software called “Mobile Phone Housekeeper,” which integrates the following multiple functions: monitoring usage flows and battery charge status, making software recommendations and backing up contacts. There is a need for an easy-to-use navigation interface that allows users to switch between functional modules conveniently.

Traditional navigation interfaces in the operating systems of smartphones such as iOS use tabs. However, such interfaces present certain disadvantages: for example, only five tabs can be displayed at most, and the tabs will always occupy parts of the screen in the user interface. Since mobile phones only have limited screen space, such interfaces make it very difficult to display a lot of information. Also, users get distracted by the tabs while using the interface, and different modules cannot function as independent entities.

### SUMMARY OF THE DISCLOSURE

There is a need for a method and device for interface display to avoid the disadvantages of traditional navigation interfaces with tabs and to allow users to conveniently switch between functional modules.

An interface display method comprises: generating a first screen interface and a second screen interface, wherein the first screen interface displays a functional interface associated with an application, and the second screen interface displays a navigation interface comprising functional modules associated with the application; displaying the first screen interface; displaying the second screen interface when the second screen interface is triggered; and displaying an interface associated with a functional module in the first screen interface when the functional module is selected from the second screen interface.

An interface display device comprises: an interface generating module that generates a first screen interface and a second screen interface, wherein the first screen interface displays a functional interface associated with an application, and the second screen interface displays a navigation interface comprising functional modules associated with the application; an interface display module that displays the first screen interface; a detection module that enables the interface display module to display the second screen interface when the second screen interface is triggered; and a switching module that enables the interface display module to display an interface associated with a functional module in the first screen interface when the functional module is selected from the second screen interface.

Pursuant to the interface display method and in the interface display device described above, a mobile phone interface can be divided into two screens, i.e., a first screen and a second screen. This changes the way of interface navigation from the traditional display at the bottom of the first screen to a linear display on the second screen, which is hidden to the left of the first screen. By putting the navigation interface into a sidebar, this interactive form not only increases the scalability of the navigation function, but also simplifies a user's mobile phone screen interface, thereby ensuring that the screen provides the user a clear and more independent content display, and allowing the user to get a better and more focused experience.

### BRIEF DESCRIPTION OF THE DRAWINGS

FIG. 1 is a schematic diagram illustrating an example of the flow of an interface display method according to various embodiments.

FIG. 2 is a schematic diagram illustrating an example of a first screen interface displayed in accordance with an interface display method according to various embodiments.

FIG. 3 is a schematic diagram illustrating an example of a second screen interface displayed in accordance with an interface display method according to various embodiments.

FIG. 4 is a schematic diagram illustrating an example of a second screen interface being triggered in accordance with an interface display method according to various embodiments.

FIG. 5 is a schematic diagram illustrating an example of an arrangement of an interface display device according to various embodiments.

### DETAILED DESCRIPTION

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

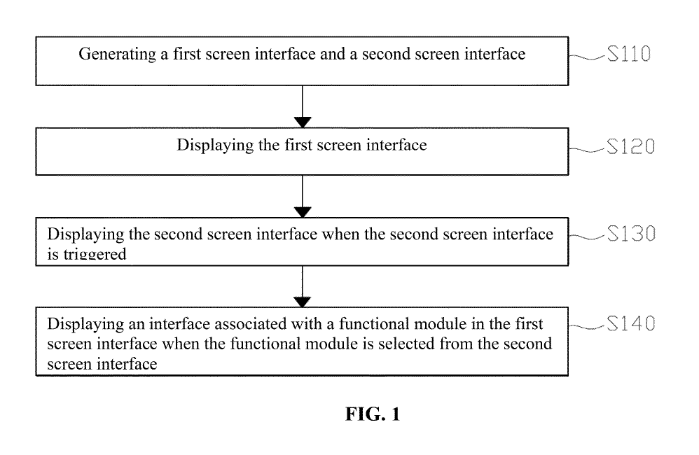

FIG. 1 is a schematic diagram illustrating an example of the flow of an interface display method according to various embodiments. The method can comprise:

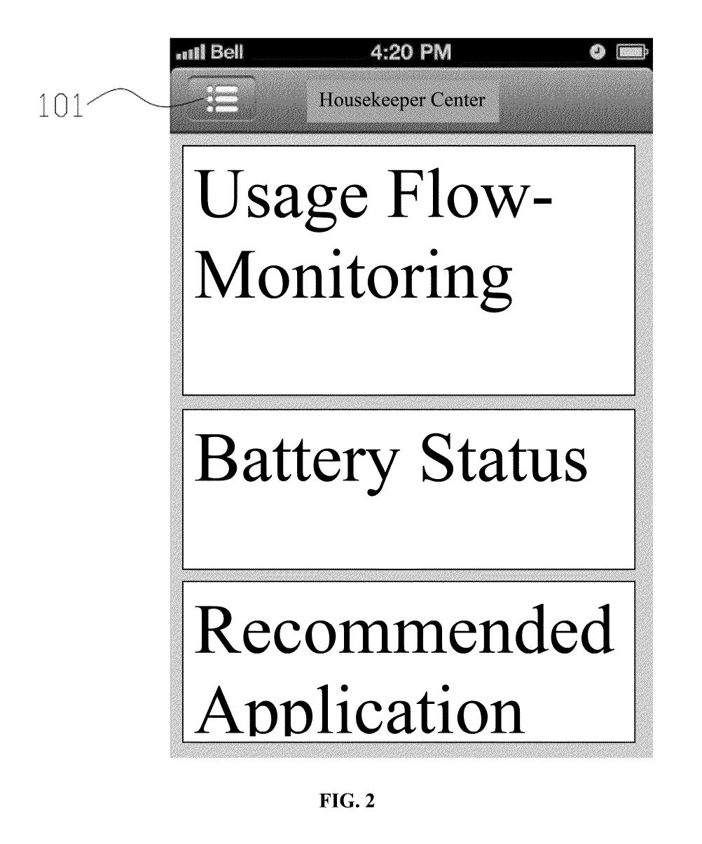

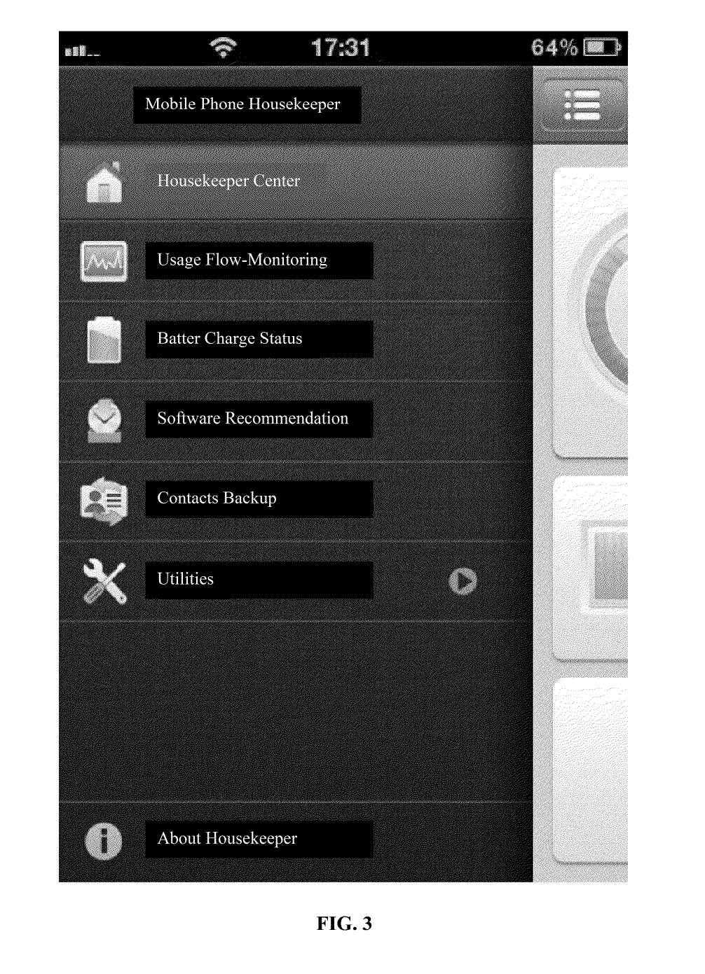

Step S110: generating a first screen interface and a second screen interface. As illustrated in FIG. 2, the first screen interface can display a functional interface associated with an application. According to some embodiments, after an application is started, a default interface associated with the application can be displayed. The default interface can include contents that are of interest to a user. By way of example only, the application can comprise a mobile phone managing application and can display such contents of interest to a user as usage flow-monitoring, battery status, and application recommendations, etc. As illustrated in FIG. 3, the second screen interface can display a navigation interface comprising functional modules associated with the application. According to some embodiments, the functional modules can be listed in the navigation interface in the form of a list. According to some embodiments, Step S110 can be completed during the startup process of an application program.

Step S120: displaying the first screen interface. According to some embodiments and as illustrated in FIGS. 2-3, it is possible to display only the first screen interface and not the second screen interface under a default state. According to some other embodiments, the second screen interface can be displayed under a default state. However, regardless of whether the first screen interface or the second screen interface is displayed under the default state, when the application is under a state of normal use, according to some preferred embodiments, the second screen interface is hidden and only the first screen interface is displayed.

Step S130: displaying the second screen interface when the second screen interface is triggered. According to some embodiments and as illustrated in FIG. 2, the first screen interface can display a virtual button 101. The second screen interface can be triggered when the system detects that the virtual button 101 is pressed, thereby displaying the second screen interface. The transition from FIG. 2 to FIG. 3 indicates the triggering of the second screen interface. A user can then complete a selection operation on the functional modules displayed in the interface illustrated by FIG. 3.

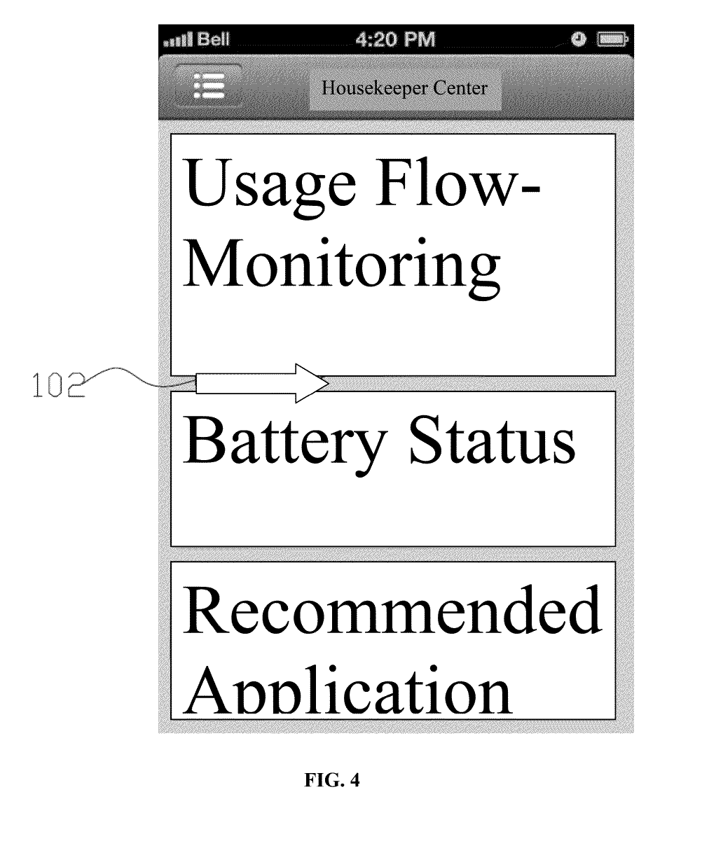

Those of ordinary skill in the art can readily appreciate that in addition to pressing a virtual button 101 as described above, there are multiple ways in which the second screen interface can be triggered. By way of example only, the second screen interface can be triggered by a gesture. For example and as illustrated in FIG. 4, the second screen interface can be triggered when the system detects a gesture, e.g., a left-to-right sliding gesture 102, when the first screen interface is displayed.

According to some embodiments, a command to trigger the second screen interface can be obtained by activating a physical button. According to some embodiments, a physical button can be a particular preset button on a mobile device. According to these embodiments, when pressing that button, a command to trigger the second screen interface can be obtained.

According to some embodiments, a command to trigger the second screen interface can be generated by obtaining a shaking operation on a mobile device. According to some embodiments, an acceleration sensor can be set up on a mobile device to detect the acceleration data of the mobile device in multiple directions. When the acceleration data is detected to be within a preset range, a shaking operation on the mobile device is obtained, thereby generating a command to trigger the second screen interface.

Step S140: displaying an interface associated with a functional module in the first screen interface when the functional module is selected from the second screen interface. For example and as illustrated in FIG. 3, the screen can return to the interface illustrated in FIG. 2 when a user selects a functional module in the second screen interface, e.g., the “Housekeeper Center” illustrated in FIG. 3. Similarly, when other functional modules are selected, the first screen interface can display their corresponding interfaces.

According to some embodiments, when the second screen interface is triggered pursuant to Step S130 above, the first screen interface and the second screen interface can be moved together from one side of the screen to the opposite side of the screen so that the second screen interface moves in and the first screen interface moves out of the screen. According to some embodiments, the second screen interface does not have to occupy the entire screen. As illustrated in FIG. 3, for example, when the first screen interface and the second screen interface are moved across the screen from left to right, the width of the second screen interface can be smaller than the width of the screen such that when the left edge of the second screen interface is aligned with the left edge of the screen, the right edge of the second screen interface is still a certain distance away to the right edge of the screen. As a result, part of the content in the first screen interface is still displayed on the screen.

In the example described above, the second screen interface is positioned to the left of the first screen interface. However, those skilled in the art will readily appreciate that the present disclosure is not limited to such positioning. For example, the second screen interface can be positioned above, below, or to the right of the first screen interface. Accordingly, the second screen interface can be triggered by a downward, upward, or right-to-left sliding gesture, respectively.

Pursuant to the interface display method described above, a mobile phone interface can be divided into two screens, i.e., a first screen and a second screen. This changes the way of interface navigation from the traditional display at the bottom of the first screen to a linear display on the second screen, which is hidden to the left of the first screen. By putting the navigation interface into a sidebar, this interactive form not only increases the scalability of the navigation function, but also simplifies a user's mobile phone screen interface, thereby ensuring that the screen provides the user a clear and more independent content display, and allowing the user to get a better and more focused experience.

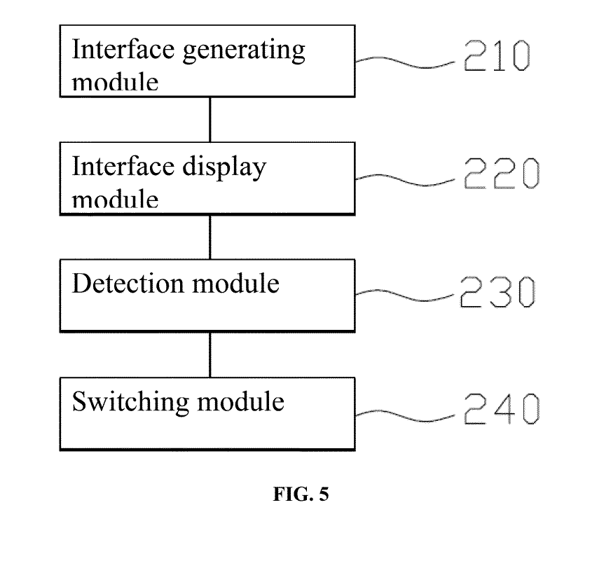

FIG. 5 is a schematic diagram illustrating an example of an arrangement of an interface display device according to various embodiments. The interface display device 200 can comprise: an interface generating module 210, an interface display module 220, a detection module 230, and a switching module 240.

The interface generating module 210 generates a first screen interface and a second screen interface. As illustrated in FIG. 2, the first screen interface can display a functional interface associated with an application. According to some embodiments, after an application is started, a default interface associated with the application can be displayed. The default interface can include contents that are of interest to a user. By way of example only, the application can comprise a mobile phone managing application and can display such contents of interest to a user as usage flow-monitoring, battery status, and application recommendations, etc. As illustrated in FIG. 3, the second screen interface can display a navigation interface comprising functional modules associated with the application. According to some embodiments, the functional modules can be listed in the navigation interface in the form of a list.

The interface display module 220 displays the first screen interface. According to some embodiments and as illustrated in FIGS. 2-3, it is possible to display only the first screen interface and not the second screen interface under a default state. According to some other embodiments, the second screen interface can be displayed under a default state. However, regardless of whether the first screen interface or the second screen interface is displayed under the default state, when the application is under a state of normal use, according to some preferred embodiments, the second screen interface is hidden and only the first screen interface is displayed.

The detection module 230 enables the interface display module 220 to display the second screen interface when the second screen interface is triggered. According to some embodiments, the detection module 230 calls the interface display module 220 to display the second screen interface when the second screen interface is triggered. According to some embodiments and as illustrated in FIG. 2, the first screen interface can display a virtual button 101. The second screen interface can be triggered when the detection module 230 detects that virtual button 101 is pressed, thereby displaying the second screen interface. The transition from FIG. 2 to FIG. 3 indicates the triggering of the second screen interface. A user can then complete a selection operation on the functional modules displayed in the interface illustrated by FIG. 3.

According to some embodiments, the second screen interface can be triggered when the detection module 230 detects that a physical button is activated. According to some embodiments, a physical button can be a particular preset button on a mobile device. According to these embodiments, when pressing that button, a command to trigger the second screen interface can be obtained.

According to some embodiments, the second screen interface can be triggered when the detection module 230 detects a shaking operation on a mobile device. According to some embodiments, an acceleration sensor can be set up on a mobile device to detect the acceleration data of the mobile device in multiple directions. When the acceleration data is detected to be within a preset range, a shaking operation on the mobile device is obtained, thereby generating a command to trigger the second screen interface.

The switching module 240 enables the interface display module 220 to display an interface associated with a functional module in the first screen interface when it detects that the functional module is selected from the second screen interface. According to some embodiments, the switching module 240 calls the interface display module 220 to display an interface associated with a functional module in the first screen interface when it detects that the functional module is selected from the second screen interface. For example and as illustrated in FIG. 3, the screen can return to the interface illustrated in FIG. 2 when a user selects a functional module in the second screen interface, e.g., the “Housekeeper Center” illustrated in FIG. 3. Similarly, when other functional modules are selected, the first screen interface can display their corresponding interfaces.

According to some embodiments, when the second screen interface is triggered, the first screen interface and the second screen interface can be moved together from one side of the screen to the opposite side of the screen so that the second screen interface moves in and the first screen interface moves out of the screen. According to some embodiments, the second screen interface does not have to occupy the entire screen. As illustrated in FIG. 3, for example, when the first screen interface and the second screen interface are moved across the screen from left to right, the width of the second screen interface can be smaller than the width of the screen such that when the left edge of the second screen interface is aligned with the left edge of the screen, the right edge of the second screen interface is still a certain distance away to the right edge of the screen. As a result, part of the content in the first screen interface is still displayed on the screen.

In the example described above, the second screen interface is positioned to the left of the first screen interface. However, those skilled in the art will readily appreciate that the present disclosure is not limited to such positioning. For example, the second screen interface can be positioned above, below, or to the right of the first screen interface. Accordingly, the second screen interface can be triggered by a downward, upward, or right-to-left sliding gesture, respectively.

In the interface display device described above, a mobile phone interface can be divided into two screens, i.e., a first screen and a second screen. This changes the way of interface navigation from the traditional display at the bottom of the first screen to a linear display on the second screen, which is hidden to the left of the first screen. By putting the navigation interface into a sidebar, this interactive form not only increases the scalability of the navigation function, but also simplifies a user's mobile phone screen interface, thereby ensuring that the screen provides the user a clear and more independent content display, and allowing the user to get a better and more focused experience.

The interface display device in the various embodiments described hereinabove can be run on mobile devices. A mobile device can be a mobile phone, a tablet PC, a media player, etc. Examples of mobile devices that can be used in accordance with various embodiments include, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), a media player (including, but not limited to, Apple iPod and Microsoft Zoom), or an on-vehicle device running any of the above-mentioned operating systems or any other operating systems, or any other mobile Internet device (“MID”) or intelligent communication terminal, all of which are well known to those skilled in the art.

Persons of ordinary skill in the art can readily appreciate that all or part of the steps of the methods described in the embodiments above can be executed by relevant hardware instructed by a program that may be stored in a computer-readable memory medium. The readable memory medium may be, for example, a read-only memory (“ROM”), a random access memory (“RAM”), a magnetic disk or a compact disc.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1. An interface display method comprising:
generating a first screen interface and a second screen interface, wherein the first screen interface displays a functional interface associated with an application, and the second screen interface displays a navigation interface comprising functional modules associated with the application,
displaying the first screen interface,
displaying the second screen interface when the second screen interface is triggered, and
displaying an interface associated with a functional module in the first screen interface when the functional module is selected from the second screen interface.

2. The method of claim 1, wherein displaying the second screen interface comprises moving the second screen interface into a current screen.

3. The method of claim 2, wherein displaying the second screen interface comprises moving the first screen interface out of the current screen.

4. The method of claim 3, wherein at least part of the first screen interface is displayed in the current screen when the second screen interface is displayed in the current screen.

5. The method of claim 1, wherein the first screen interface comprises a virtual button, and the second screen interface is triggered by a pressing of the virtual button.

6. The method of claim 1, wherein the second screen interface is triggered by a gesture when the first screen interface is displayed.

7. The method of claim 6, wherein the gesture comprises a left-to-right sliding gesture.

8. The method of claim 1, wherein the second screen interface is triggered by an activation of a physical button.

9. The method of claim 1, wherein the second screen interface is triggered by a shaking of a mobile device.

10. The method of claim 1, wherein the application comprises a mobile phone managing application.

11. An interface display device comprising:
an interface generating module that generates a first screen interface and a second screen interface, wherein the first screen interface displays a functional interface associated with an application, and the second screen interface displays a navigation interface comprising functional modules associated with the application,
an interface display module that displays the first screen interface,
a detection module that enables the interface display module to display the second screen interface when the second screen interface is triggered, and
a switching module that enables the interface display module to display an interface associated with a functional module in the first screen interface when the functional module is selected from the second screen interface.

12. The device of claim 11, wherein the interface display module moves the second screen interface into a current screen when the second screen interface is triggered.

13. The device of claim 12, wherein the interface display module moves the first screen interface out of the current screen when the second screen interface is triggered.

14. The device of claim 13, wherein at least part of the first screen interface is displayed in the current screen when the second screen interface is displayed in the current screen.

15. The device of claim 11, wherein the first screen interface comprises a virtual button and the second screen interface is triggered by a pressing of the virtual button.

16. The device of claim 11, wherein the second screen interface is triggered by a gesture when the first screen interface is displayed.

17. The device of claim 16, wherein the gesture comprises a left-to-right sliding gesture.

18. The device of claim 11, wherein the second screen interface is triggered by an activation of a physical button.

19. The device of claim 11, wherein the second screen interface is triggered by a shaking of a mobile device.

20. The device of claim 11, wherein the application comprises a mobile phone managing application.
